(19) United States
(12) Patent Application Publication
(10) Pub. No.: US 2014/0082391 A1
(43) Pub. Date: Mar. 20, 2014

(54) COMPUTER SYSTEM AND POWER MANAGEMENT METHOD

(71) Applicant: ACER INCORPORATED, Taipei Hsien (TW)

(72) Inventor: Kim Yeung SIP, Taipei Hsien (TW)

(73) Assignee: ACER INCORPORATED, Taipei Hsien (TW)

(21) Appl. No.: 13/687,755

(22) Filed: Nov. 28, 2012

(30) Foreign Application Priority Data
Sep. 14, 2012 (TW) 101133608

(51) Int. Cl. G06F 1/32

(52) U.S. Cl. CPC G06F 1/3203
USPC 713/323

(57) ABSTRACT

A computer system is provided. The computer system has: a processor; a network transmission module; a storage unit; and a dual-port disk controller, coupled to the processor, the network transmission module and the storage unit, configured to control access of the storage unit, wherein when the computer system is in a connected-standby state and the processor is operating in a low power state, the network transmission module receives network data of the at least one background activity from a network, and writes the received network data to the storage unit directly through the dual-port disk controller.

### CROSS REFERENCE TO RELATED APPLICATIONS

This Application claims priority of Taiwan Patent Application No. 101133608, filed on Sep. 14, 2012, the entirety of which is incorporated by reference herein.

### BACKGROUND OF THE INVENTION

1. Field of the Invention

The present invention relates to power management, and in particular, relates to a computer system and power management method for downloading background activities data without using the processor in the connected-standby state.

2. Description of the Related Art

FIG. 1A is a simplified block diagram of a conventional computer system 100. The computer system 100 may comprise a processor 110, a network transmission module 120, a disk controller 130 and a storage unit 140. For example, the processor 110 may support “Advanced Configuration and Power Interface (hereafter as ACPI)” and function in the “Connected-Standby” state (e.g. supported by Microsoft Windows 8). When the computer system 100 is in the connected-standby state, the processor 110 is in a low power state (e.g. C7 or C10 state defined by ACPI). Although applications are suspended in the low power state, the computer system 100 may keep a connection with the network (e.g. Wifi network or local network) through the network transmission module 120.

In other words, before entering the low power state, the processor 110 may suspend all of the applications which are being executed, and then enter the low power state. When the network transmission module 120 receives update information associated with an application, the processor 110 may be awaken from the low power state for processing the received information, and then enter the low power state again after processing all of the received information. Accordingly, the computer system 100 may display the latest message instantaneously, so that the user may view the latest information, such as e-mails or message notifications.

FIG. 1B is a diagram illustrating polling of the convention computer system 100 in the connected-standby state. When the computer system 100 is in the connected-standby state, the processor 110 is in the low power state for most of the time, and the network transmission module 120 is in the working state to receive data from the network (e.g. data of background activities). The processor 110 is awaken during a fixed time period by default for processing data of background activities (e.g. displaying e-mails or short messages) or processing downloaded files or attachment files of e-mails. As shown in FIG. 1B, the y axis indicates the power consumption of the processor 110. The processor 110 is awaken for 500 milliseconds for processing background activities every 30 seconds in the connected-standby state.

Upon receiving information from the network, the network transmission module 120 in the conventional computer system 100 must access the data stored in the storage unit 140 through the processor 110, and thus the processor 110 cannot fully be under the low power state during the predetermined sleeping period (e.g. the 30-second period shown in FIG. 1B) of the connected-standby state. For example, when the processor 110 is in the low power state and the network transmission module 120 receives new information, the network transmission module may wake up the processor 110 and transmit the received new information to the processor 110 even though the predetermined sleeping period has not expired. Then, the processor 110 may store the received new information to the storage unit 140, and enter the low power state after processing the received new information. Accordingly, the power consumption of the computer system 100 increases as the processing time of the processor 110 increases.

Therefore, there is a demand for a computer system and a power management method, which are capable of avoiding the periodic waking up of the processor during the predetermined sleeping period of the processor in the connected-standby state, thereby effectively reducing the power consumption of the computer system.

### BRIEF SUMMARY OF THE INVENTION

A detailed description is given in the following embodiments with reference to the accompanying drawings.

In an exemplary embodiment, a computer system is provided. The computer system has: a processor; a network transmission module; a storage unit; and a dual-port disk controller, coupled to the processor, the network transmission module and the storage unit, configured to control access of the storage unit, wherein when the computer system is in a connected-standby state and the processor is operating in a low power state, the network transmission module receives network data of the at least one background activity from a network, and writes the received network data to the storage unit directly through the dual-port disk controller.

In another exemplary embodiment, a power management method applied in a computer system is provided. The computer system has a processor; a network transmission module; a storage unit; and a dual-port disk controller. The method comprises the following steps of: utilizing the network transmission module to receive network data of the at least one background activity from a network when the computer system is in a connected-standby state and the processor is operating in a low power state; and utilizing the network transmission module to write the received network data to the storage unit directly through the dual-port disk controller.

### BRIEF DESCRIPTION OF THE DRAWINGS

The present invention can be more fully understood by reading the subsequent detailed description and examples with references made to the accompanying drawings, wherein:

FIG. 1A is a simplified block diagram of a conventional computer system 100;

FIG. 1B is a diagram illustrating polling of the convention computer system 100 in the connected-standby state;

FIG. 2 is a simplified block diagram of a computer system 200 according to an embodiment of the invention;

FIG. 3 is a diagram illustrating the polling states of the processor 210 according to an embodiment of the invention;

FIG. 4 is a flow chart illustrating the power management method according to an embodiment of the invention.

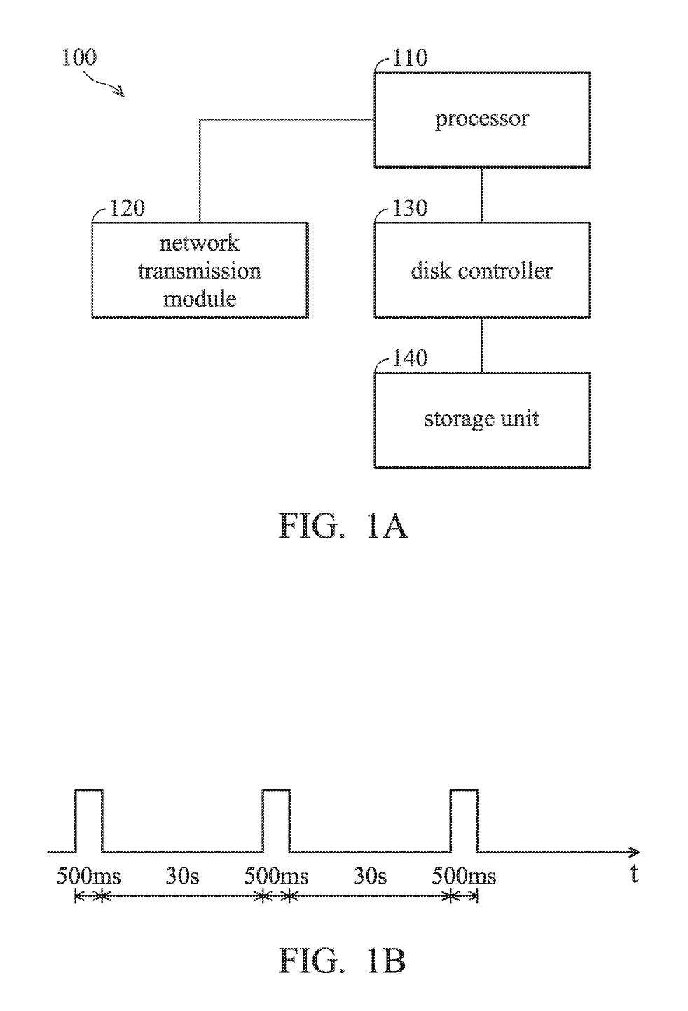

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

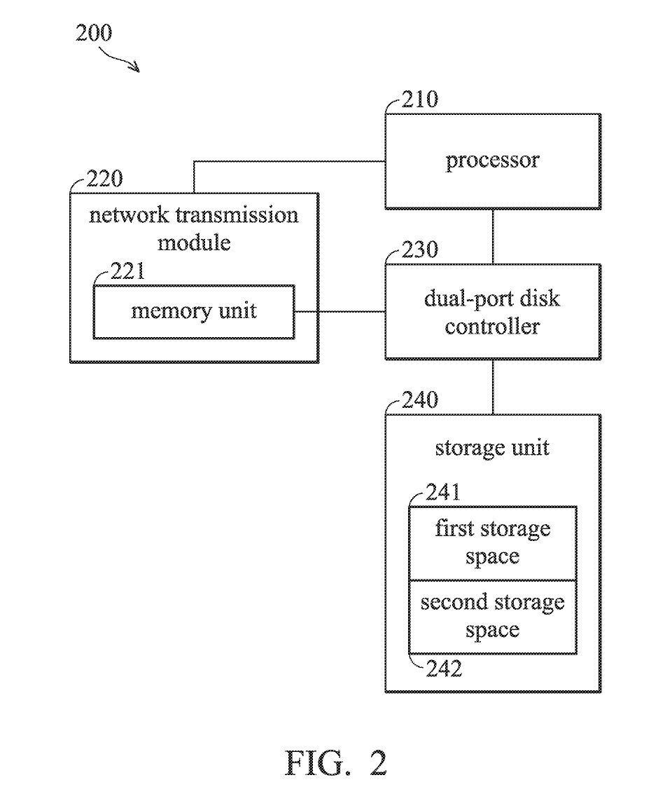

FIG. 2 is a simplified block diagram of a computer system 200 according to an embodiment of the invention. The computer system 200 may comprise a processor 210, a network transmission module 220, a dual-port disk controller 230, and a storage unit 240. For example, the computer system 200 may be a personal computer (PC), a laptop, a smart phone or a tablet PC, but the invention is not limited thereto.

In an embodiment, the processor 210 may support ACPI and function in the connected-standby state. When the computer system enters the connected-standby state, the processor 210 is in a low power state (e.g. C7 or C10 state defined by ACPI). Although the applications which are being executed are suspended by the processor 210, these suspended applications may still keep a connection to the network (e.g. Wifi network or local network) through the network transmission module 220. In other words, when the computer system 200 enters the connected-standby state, the applications executed by the processor 210 before entering the low power state may consistently be updated by receiving new information, so that the new information can be instantaneously received and processed. For example, the user may instantaneously view the latest data or applications, such as e-mails or notification messages, after booting up the computer system 200.

The dual-port disk controller 230 is coupled to the processor 210 and the network transmission module 220, and configured to control the access of the storage unit 240, such as simultaneously processing the access (e.g. writing and reading) actions from the processor 210 and the network transmission module 220 to the storage unit 240. Specifically, the computer system 200 supports the connected-standby function. As long as the computer system 200 is activated, the network transmission module 220, the dual-port disk controller 230 and the storage unit 240 are always active no matter whether the computer system 200 is in the connected-standby state or not.

In the aforementioned embodiment, the network transmission module 220 further comprises a memory unit 221 configured to store data (e.g. e-mails or notification messages) from the network temporarily. Specifically, when the computer system 200 is in the working state and the network transmission module 220 receives network data from a network, the network transmission module 220 may store the received network data in the memory unit 221, and then writes the network data stored in the memory unit 221 to the storage unit 240 directly through the dual-port disk controller 230. For example, the memory unit 221 may be a first-in-first-out (FIFO) buffer, but the invention is not limited thereto.

In an embodiment, the storage unit 240 can be classified into a first storage space 241 and a second storage space 242. The first storage space 241 is configured to store the received network data (e.g. main texts in e-mails or notification messages) when the computer system 200 is in the connected-standby state. The second storage space 242 is configured to store files with larger sizes, such as operating systems, applications, multimedia files in the received network data, or attachment files of e-mails. In other words, the operating system and applications of the computer system 200 are stored in the second storage space 242. For example, the storage unit 240 may be a non-volatile memory, such as a hard disk or a solid state disk (SSD), but the invention is not limited thereto.

In an embodiment, when the computer system 200 is in the working state and the network transmission module 220 receives network data from a network, the network transmission module 220 may directly transmit the received network data to the processor 210, and then the processor 210 may store the network data in the storage unit 240 through the dual-port disk controller 230. In another embodiment, the network transmission module 220 may classify the received network data into data with a longer length and data with a shorter length. For example, the network transmission module 220 may store the data with a longer length, such as attachment files of e-mails or downloaded files, into the second storage space 242, and transmit the data with a shorter length, such as main texts of e-mails, text messages, or MSN messages, to the processor 210, so that the processor 210 may directly display these messages.

In an embodiment, when the computer system 200 is in the connected-standby state and the processor 210 is processing background activities, all the downloaded network data is processed by the network transmission module 220 without passing through the processor 210. For example, when the network transmission module 220 receives network data from a network, the network transmission module 220 may control the dual-port disk controller 230 to store the received network data into the storage unit 240. The processor 210 is periodically awaken in the connected-standby state to process the stored network data to notify the user.

The background activities may be the suspended applications which are not sensible to the user in the connected-standby state. In other words, although the computer system 200 is in the connected-standby state, it still has to receive network data from the network, but the user can not sense any application being executed by the computer system 200. In fact, there are some hardware components in the computer system 200 to process these background activities, such as receiving network data through the network transmission module 220, or waking up the processor 210 periodically to execute applications (e.g. playing music, checking e-mails, displaying notification message or executing anti-virus applications).

When the processor 210 is awaken periodically to process the applications of background activities, the processor 210 may check whether the network data of related applications are stored in the first storage space 241. If so, the processor 210 may generate corresponding display data, such as notification of e-mails or messages, and then the processor 210 may further display the generated display data on a screen (not shown in FIG. 2) of the computer system 200.

As for ways for processing the downloaded data, the network transmission module 220 may store the network with a smaller size, such as main texts of e-mails or notification messages, in the first storage space 241, and store the network data with a larger size, such as attachment files of e-mails or downloaded files, in the second storage space 242. Accordingly, this may prevent the processor 210 from accessing the files with a larger size in the connected-standby state, thereby reducing power consumption.

In view of the above, four data access paths can be summarized. For example, Path (1): the computer system 200 may receive network data through the network transmission module 220 in the connected-standby state, and the network transmission module 220 may store the received network data into the storage unit 240 directly through the dual-port disk controller 230. Path (2): the background activities in the connected-standby state may take corresponding actions after checking the received network data (e.g. main texts of e-mails, notification messages, downloaded files, or attachment files of e-mails) through the aforementioned path (1) or by polling the storage unit 240 by the processor 210. Path (3): In the non-connected-standby state, if the network data received by the network transmission module 220 is data with a shorter length, such as e-mails, text messages, or MSN messages, the network transmission module 220 may transmit the received network data to the processor 210, so that the processor 210 may display these messages. Path (4): In the non-connected-standby state, if the network data received by the network transmission module 220 is data with a longer length or downloaded files, the received network data can be stored in the storage unit 240 through the aforementioned path (2), and then the processor 210 may access the storage unit 240 through the dual-port disk controller 230.

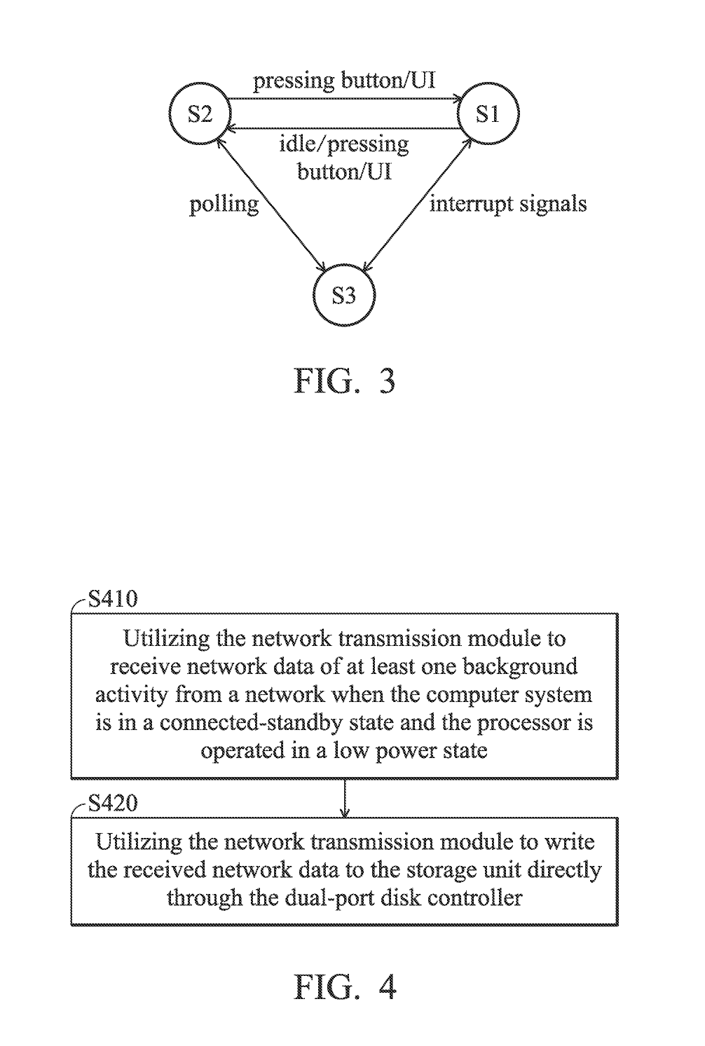

FIG. 3 is a diagram illustrating the polling states of the processor 210 according to an embodiment of the invention. In state S1, the computer system 200 is in the working state (i.e. a non-connected-standby state, such as S0ix state defined by ACPI). If (a) the computer system 200 is idle for a predetermined period, (b) the standby button is pressed by the user, or (c) the standby state is selected from the user interface, the computer system 200 may enter state S2, which is the connected-standby state. Further, when the processor 210 receives interrupt signals from other devices (e.g. interrupt signals from the PCI-E bus or the SDIO controller) in state S1, the computer system 200 may enter state S3. That is, the processor 210 may take corresponding data access actions, such as reading notification messages or e-mails from the first storage space 241, or reading the downloaded files or attachment files of e-mails from the second storage space 242. In state S2, the computer system 200 is in the connected-standby state, and the processor 210 is only awaken periodically (e.g. awaken for 500 milliseconds every 30 seconds) to poll the jobs to be processed. When there are background activities being executed, the network transmission module 220 may store the network data in the storage unit 240 for polling by the processor 210 to check the data of background activities, and then the computer system 200 enters state S3. In addition, the user may press the standby button again or performing wake-up actions (e.g. disabling screen lock, moving the mouse) to exit the connected-standby state, and then the computer system 200 may go back to the working state S1. In state S3, when the processor 210 has completed data transmission, the processor 210 may go back to the corresponding previous state. That is, the processor 210 may go back to the working state (e.g. state S1) or the low power state (e.g. state S2).

It should be noted that when the computer system 200 is in the connected-standby state and the processor 210 is polling data, the processor 210 only has to process the network data with a smaller size (e.g. main texts of e-mails or notification messages) stored in the first storage space 241 without wasting much power to process the network data with a larger size (e.g. downloaded files or attachment files of e-mails stored in the second storage space 242). Accordingly, the operation time and power of the processor 210 during background activities periods can be reduced in the invention.

FIG. 4 is a flow chart illustrating the power management method according to an embodiment of the invention. In step S410, when the computer system 200 is in a connected-standby state and the processor 210 is operating in a low power state, the network transmission module 220 may receive network data of the at least one background activity from a network. In step S420, the network transmission module 220 writes the received network data to the storage unit 240 directly through the dual-port disk controller 230. It should be noted that the processor 210 uses a polling method to check the network data stored in the storage unit 240 when the computer system 200 is in the connected-standby state. That is, only the network data with a smaller size is checked in the connected-standby state, thereby preventing more power consumption.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer system, comprising:
a processor;
a network transmission module;
a storage unit; and
a dual-port disk controller, coupled to the processor, the network transmission module and the storage unit, configured to control access of the storage unit,
wherein when the computer system is in a connected-standby state and the processor is operating in a low power state, the network transmission module receives network data of at least one background activity from a network, and writes the received network data to the storage unit directly through the dual-port disk controller.

2. The computer system as claimed in claim 1, wherein the storage unit further comprises a first storage space and a second storage space.

3. The computer system as claimed in claim 2, wherein the network data is a main text of an e-mail or a notification message, and the network data is stored in the first storage space.

4. The computer system as claimed in claim 3, wherein the processor further uses a polling method to check the network data stored in the first storage space when the computer system is in the connected-standby state.

5. The computer system as claimed in claim 2, wherein the network data is a downloaded file or an attachment file of an e-mail, and the network data is stored in the second storage space.

6. The computer system as claimed in claim 5, wherein the processor further checks the network data stored in the second storage space directly through the dual-port disk controller.

7. The computer system as claimed in claim 1, wherein the processor further retrieves the network data from the network transmission module, and displays the retrieved network data when the computer system is in a working state, wherein the network data is an e-mail or a notification message.

8. A power management method applied in a computer system, the computer system comprising a processor, a network transmission module, a storage unit and a dual-port disk controller, the method comprising:
utilizing the network transmission module to receive network data of the at least one background activity from a network when the computer system is in a connected-standby state and the processor is operating in a low power state; and
utilizing the network transmission module to write the received network data to the storage unit directly through the dual-port disk controller.

9. The power management method as claimed in claim 8, wherein the storage unit further comprises a first storage space and a second storage space.

10. The power management method as claimed in claim 9, wherein the network data is a main text of an e-mail or a notification message, and the network data is stored in the first storage space.

11. The power management method as claimed in claim 10, further comprising:
utilizing the processor to use a polling method to check the network data stored in the first storage space when the computer system is in the connected-standby state.

12. The power management method as claimed in claim 9, wherein the network data is a downloaded file or an attachment file of an e-mail, and the network data is stored in the second storage space.

13. The power management method as claimed in claim 12, further comprising:
utilizing the processor to check the network data stored in the second storage space directly through the dual-port disk controller.

14. The power management method as claimed in claim 8, further comprising:
utilizing the processor to retrieve the network data from the network transmission module; and
utilizing the processor to display the retrieved network data when the computer system is in a working state,
wherein the network data is an e-mail or a notification message.
